(19) United States
(12) Patent Application Publication
(10) Pub. No.: US 2017/0118088 A1
(43) Pub. Date: Apr. 27, 2017

(54) SERVICE CHAIN MANAGEMENT APPARATUS, SERVICE CHAIN MANAGEMENT SYSTEM, SERVICE CHAIN MANAGEMENT METHOD, AND PROGRAM RECORDING MEDIUM

(71) Applicant: NEC Corporation, Minato-ku, Tokyo (JP)

(72) Inventor: Seiichi Koizumi, Tokyo (JP)

(73) Assignee: NEC Corporation, Minato-ku, Tokyo (JP)

(21) Appl. No.: 15/317,228

(22) PCT Filed: Jun. 18, 2015
(86) PCT No.: PCT/JP2015/003053

§ 371 Date: Dec. 8, 2016

(30) Foreign Application Priority Data
Jun. 19, 2014 (JP) 2014-125989

(51) Int. Cl. H04L 12/24; H04L 12/26

(52) U.S. Cl. CPC H04L 41/147; H04L 43/0852

(57) ABSTRACT

It is hard to dynamically and appropriately control, in accordance with an always varying traffic amount, the number of scales of nodes, which exhibit control delays, so as to manage the throughput performance of a service chain. A service chain management apparatus of the present invention comprises: a first formula generation means that generates a first formula associating the number of scales of nodes constituting a service chain with the processable service amount of the nodes; a second formula generation means that generates a second formula associating an increase or decrease of the number of scales with the processing delay time; a traffic prediction means that predicts a traffic amount after a given time by use of a measurement value in the service chain; and a control schedule generation means that calculates, on the basis of the first formula, a required increase or decrease of the number of scales from the service amount for which the traffic amount after the given time can be dealt with, calculates a delay time from the increase or decrease of the number of scales on the basis of the second formula, and generates, on the basis of the delay time, a control schedule in which a timing of increasing or decreasing the number of scales has been set.

### TECHNICAL FIELD

The present invention relates to a service chain management apparatus, a service chain management system, a service chain management method, and a program recording medium.

### BACKGROUND ART

IT (Information Technology) service providers provide IT services (e.g., Web servers, motion picture distribution, business systems, and the like) via a network, for terminals such as cellular phones and computers. In this case, networks used by IT services need to have network functions such as exclusion of unnecessary traffic and IP (Internet Protocol) address conversion. For example, an IT service provider that utilizes a network utilizes a service chain in which nodes that provide network functions such as LB (Load Balancer), FW (Firewall), and NAT (Network Address Translation) are connected.

An amount of traffic used in IT service always changes depending on a plurality of factors such as the number of users and the time zone. In the existing network control technologies, since various nodes are dedicated appliances, control of the throughput performance is difficult. Therefore, there is a need to adjust the amount of traffic that flows into a service chain in accordance with the throughput performance at the service chain side.

To meet this, network function virtualizing technologies, such as NFV (Network Function Virtualization) and SDN (Software Defined Networking), have been developed. These virtualizing technology allow a control of increasing (scaling out) or decreasing (scaling in) the parallel numbers of virtual instances within nodes, separately for each node such as LB or FW. By such a control, it is possible to appropriately control the throughput performance. At this time, since the scaling out/scaling in control of a node performs processes such as generation and deletion of a node instance, the changing of the network setting, and the changing of the setting within a node instance, there is a delay of about 10 minutes to 15 minutes.

An example of a system for managing such a service chain is described in PTL 1. The network system described in PTL 1 is constructed of a relay processing apparatus, such as LB or FW, a server apparatus, and a controller apparatus that provides control functions. In a network system including such a configuration, the adjustment of the throughput performance by the scaling out/scaling in of the relay processing apparatus is performed by manual operation via the controller apparatus.

Furthermore, a virtual server control system described in PTL 2, with regard to the scale control of virtual servers and the like in an object system, such as a public cloud, performs a static scale control that particularly takes into account the server load and the starting time of the object system.

### CITATION LIST

### Patent Literature

[PTL 1] International Publication No. WO 2011/049135

[PTL 2] International Publication No. WO 2013/024601

### SUMMARY OF INVENTION

### Technical Problem

In the systems described in the foregoing PTLs, it is difficult to control the throughput performance of a service chain in accordance with the amount of traffic that dynamically changes. The reason is that since the scaling out/scaling in control of various nodes involves delays, the throughput performance at the time of execution of the control becomes insufficient or excessive for the amount of traffic that occurs at the time of completion of the control.

An object of the present invention is to provide a service chain management system that can solve the foregoing problem when realizing a control of the throughput performance of a service chain in accordance with the amount of traffic that dynamically changes.

### Solution to Problem

A service chain management apparatus according to an aspect of the present invention includes: a first formula generation means that generates a first formula that formulates a relation between a scale number that indicates number of instances of a node that constitutes a service chain and an amount of service that the node is capable of processing; a second formula generation means that generates a second formula that formulates a relation between an change in the scale number and a delay time of the processing at the node; a traffic prediction means that predicts, using a measured value of an amount of traffic in the service chain, the amount of traffic that occurs after a preset time; and a control schedule generation means that, with respect to the node, calculates the change in the scale number that is needed after the preset time, from the amount of service that allows the amount of traffic that occurs after the preset time to be processed, based on the first formula, calculates the delay time from the change in the scale number, based on the second formula, and generates a control schedule in which a timing is set for the change in the scale number, based on the delay time.

A service chain management method according to another aspect of the present invention includes: generating a first formula that formulates a relation between a scale number that indicates number of instances of a node that constitutes a service chain and an amount of service that the node is capable of processing; generating a second formula that formulates a relation between a change in the scale number and a delay time of the processing at the node; predicting, by using a measured value of an amount of traffic in the service chain, the amount of traffic that occurs after a preset time; and with respect to the node, calculating the change in the scale number that is needed after the preset time, from the amount of service that allows the amount of traffic that occurs after the preset time to be processed, based on the first formula, and calculating the delay time from the change in the scale number, based on the second formula, and generating a control schedule in which a timing is set for the change in the scale number, based on the delay time.

A computer-readable program recording medium that records a program that causes a computer to execute: a process of generating a first formula that formulates a relation between a scale number that indicates number of instances of a node that constitutes a service chain and an amount of service that the node is capable of processing; a process of generating a second formula that formulates a relation between a change in the scale number and a delay time of the processing at the node; a process of predicting, by using a measured value of an amount of traffic in the service chain, the amount of traffic that occurs after a preset time; and a process of, with respect to the node, calculating the change in the scale number that is needed after the preset time, from the amount of service that allows the amount of traffic that occurs after the preset time to be processed, based on the first formula, and calculating the delay time from the change in the scale number, based on the second formula, and generating a control schedule in which a timing is set for the change in the scale number, based on the delay time.

### Advantageous Effects of Invention

According to the present invention, dynamic optimization of the throughput performance of a service chain can be realized.

### BRIEF DESCRIPTION OF DRAWINGS

FIG. 1 is a diagram illustrating an example of a service chain in which nodes that provide network functions are connected;

FIG. 2 is a block diagram illustrating an example of a configuration of a service chain management system according to a first exemplary embodiment of the present invention;

FIG. 3 is a block diagram illustrating a hardware circuit that realizes the service chain management system in the first exemplary embodiment of the present invention by using an information processing apparatus that is a computer apparatus;

FIG. 4 is a flowchart illustrating an operation of deriving a formula of a rate of operation;

FIG. 5 is a flowchart illustrating an operation of deriving a control delay formula;

FIG. 6 is a flowchart illustrating an operation of deriving a traffic amount predicting formula;

FIG. 7 is a flowchart illustrating an operation of calculating a predicted amount of traffic;

FIG. 8 is a flowchart illustrating an operation of deriving a control schedule;

FIG. 9 is a diagram illustrating an example of a traffic amount memory apparatus and data stored therein;

FIG. 10 is a diagram illustrating an example of a third formula memory unit and data stored therein;

FIG. 11 is a diagram illustrating an example of a predicted traffic memory unit and data stored therein;

FIG. 12 is a diagram illustrating an example of a control delay memory apparatus and data stored therein;

FIG. 13 is a diagram illustrating an example of a second formula memory unit and data stored therein;

FIG. 14 is a diagram illustrating an example of a first formula memory unit and data stored therein;

FIG. 15 is a diagram illustrating an example of a service time memory apparatus and data stored therein;

FIG. 16 is a diagram illustrating an example of a service chain configuration memory apparatus and data stored therein;

FIG. 17 is a diagram illustrating an example of a control schedule memory apparatus and data stored therein; and

FIG. 18 is a block diagram illustrating an example of a configuration of a service chain management apparatus according to a second exemplary embodiment of the present invention.

### DESCRIPTION OF EMBODIMENTS

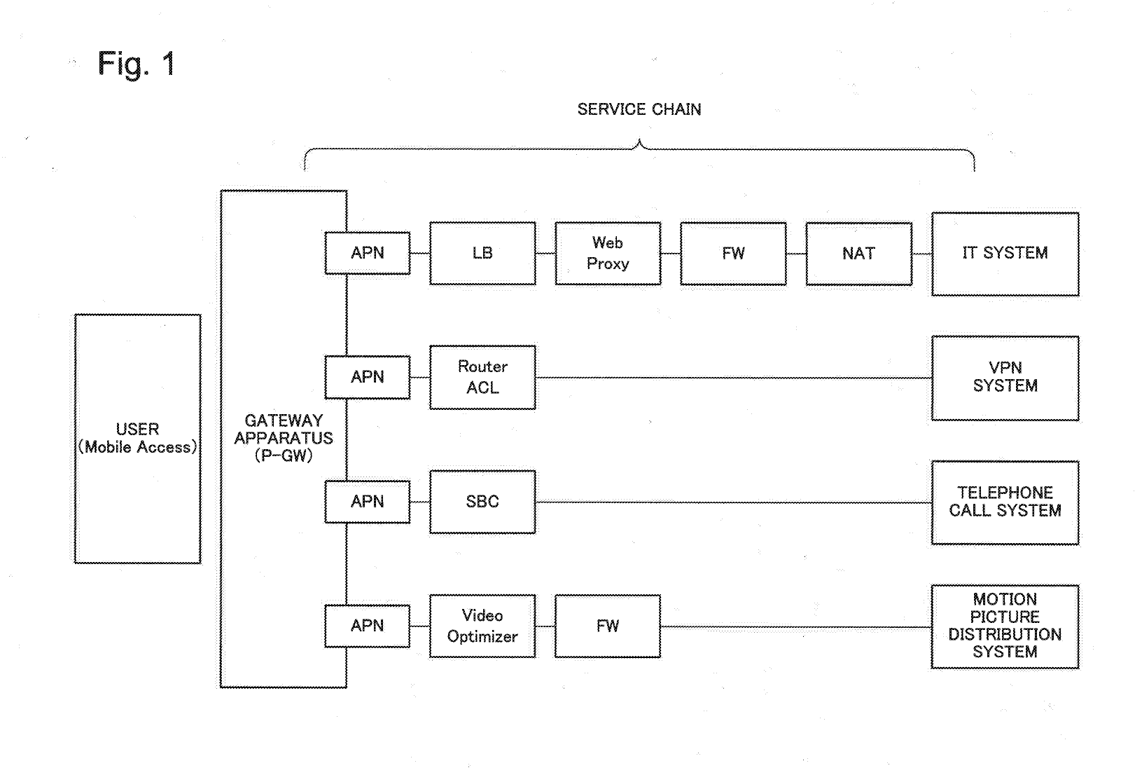

FIG. 1 is a diagram illustrating an example of a service chain in which nodes that provide network functions are connected.

FIG. 1 illustrates an example of a service chain constructed to provide various services of an IT system, a VPN (Virtual Private Network) system, a telephone call system, a motion picture distribution system, and the like, indicated at the right end, to a customer (Mobile Access) indicated at the left end.

The IT system is connected to a service chain constructed of various nodes of NAT, FW (firewall), Web Proxy, and an LB (load balancer). The VPN system is connected to a service chain constructed of a node of router ACL (Access Control List). The telephone call system is connected to a service chain constructed of a node of an SBC (Session Border Controller). The motion picture distribution system is connected to a service chain constructed of various nodes of FW and Video Optimizer.

Note that the service chains are connected to a user (Mobile Access) via APNs (Access Point Names) and a gateway apparatus (P-GW: Packet Data Network-gateway).

Next, a first aspect for carrying out the present invention will be described in detail with reference to the drawings.

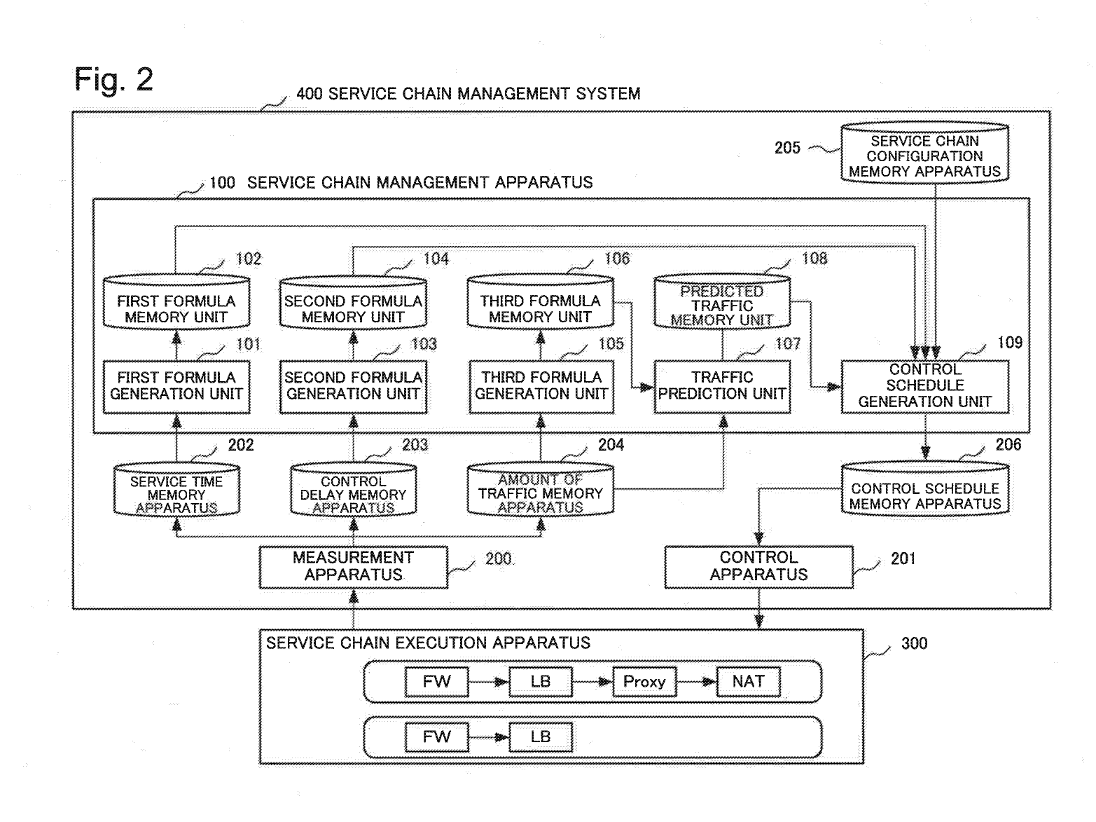

FIG. 2 is a block diagram illustrating an example of a configuration of a service chain management system 400 according to the first exemplary embodiment of the present invention.

Referring to FIG. 2, the service chain management system 400 includes a service chain management apparatus 100, a measurement apparatus 200, a control apparatus 201, a service time memory apparatus 202, a control delay memory apparatus 203, a traffic amount memory apparatus 204, a service chain configuration memory apparatus 205, and a control schedule memory apparatus 206.

Furthermore, a service chain execution apparatus 300 provides an environment in which a plurality of service chains operates as illustrated in FIG. 1.

Note that FIG. 2 describes, as examples of service chains, a configuration in an upper row made up of an FW, an LB, a Proxy, and a NAT and a configuration in a lower row made up of an FW and a DPI (Deep Packet Inspection).

The service chain management apparatus 100 includes a first formula generation unit 101, a first formula memory unit 102, a second formula generation unit 103, a second formula memory unit 104, a third formula generation unit 105, a third formula memory unit 106, a traffic prediction unit 107, a predicted traffic memory unit 108, and a control schedule generation unit 109.

The first formula generation unit 101 generates a formula (first formula) for the rate of operation which formulates a relation between the scale number that indicates the number of instances of a node that constitutes a service chain and the amount of service that the node is capable of processing.

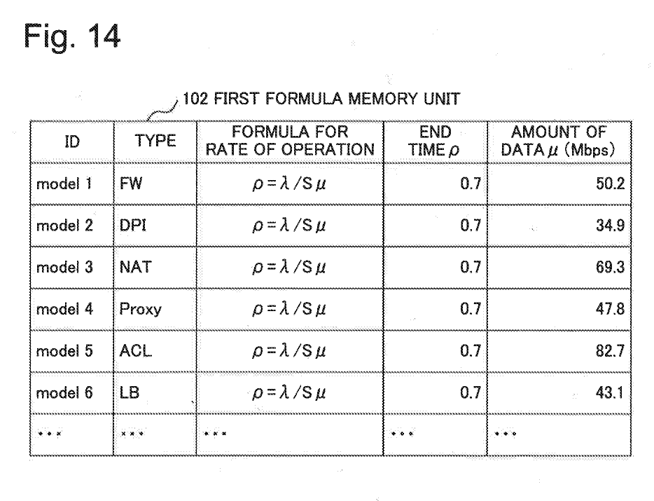

The first formula memory unit 102 stores a formula generated by the first formula generation unit 101. Data stored in the first formula memory unit 102 will be described later with reference to FIG. 14.

The second formula generation unit 103 generates a control delay formula (second formula) that formulates a relation between the increase or decrease of the scale number and the delay time of the processes by the node.

The second formula memory unit 104 stores the control delay formula generated by the second formula generation unit 103. Data stored in the second formula memory unit 104 will be described later with reference to FIG. 13.

The third formula generation unit 105 derives a traffic predicting formula (third formula) that represents changes in the amount of traffic by using measured values of the amount of traffic.

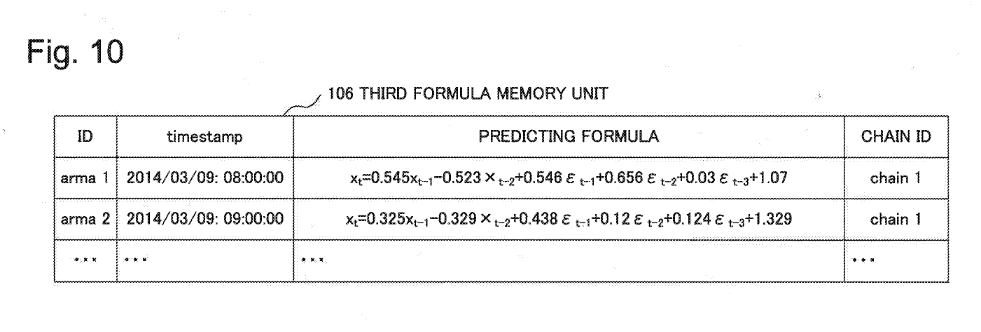

The third formula memory unit 106 stores the traffic predicting formula derived by the third formula generation unit 105. Data stored in the third formula memory unit 106 will be described later with reference to FIG. 10.

The traffic prediction unit 107 predicts the amount of traffic that will occur in a preset time by using measured values of the amount of traffic in a service chain and the traffic predicting formula stored in the third formula memory unit 106.

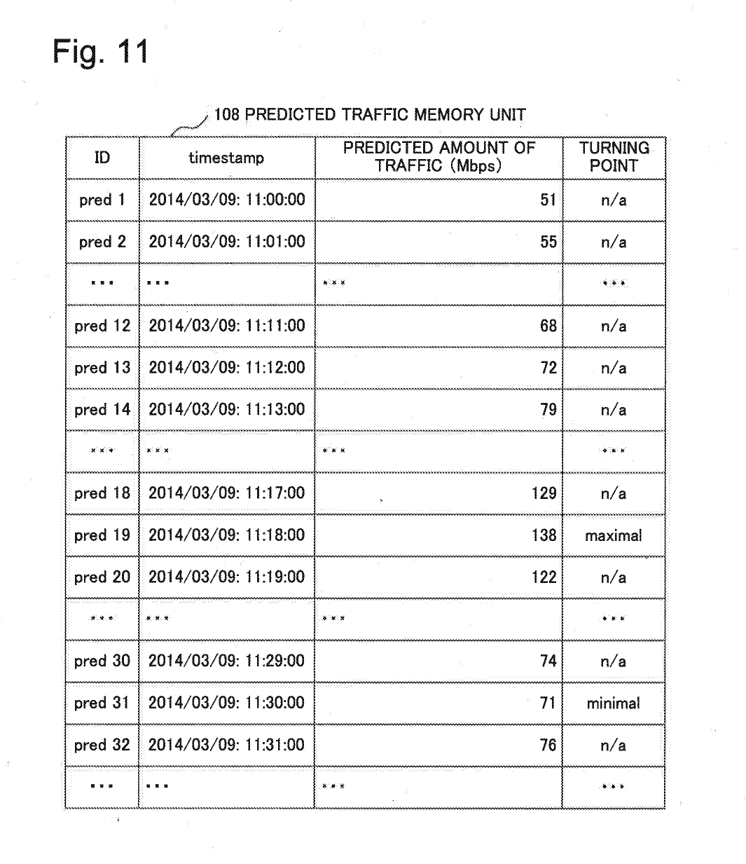

The predicted traffic memory unit 108 stores the amount of traffic predicted by the traffic prediction unit 107 (hereinafter, also referred to as the predicted amount of traffic). Data stored in the predicted traffic memory unit 108 will be described later with reference to FIG. 11.

Note that the first formula memory unit 102, the second formula memory unit 104, the third formula memory unit 106, and the predicted traffic memory unit 108 may each be constructed of one or two memory apparatuses and are not limited to the configuration illustrated in FIG. 2.

The control schedule generation unit 109 determines a control schedule that includes a change in the scale number of a node that constitutes a service chain and the timing to start the control based on the formula of rate of operation, a change in the future amount of traffic (predicted amount of traffic), and the node's control delay (the control delay formula).

The measurement apparatus 200 connects to each of the service time memory apparatus 202, the control delay memory apparatus 203, and the traffic amount memory apparatus 204. The measurement apparatus 200 performs various various measurements on the service chain execution apparatus 300 to generate various kinds of measured data. The measurement apparatus 200 stores the measured data into memory apparatuses in accordance with each kind of measured data. The measured data include the service time for a service chain, the amount of data, the process delay times occurring when the scale number is changed for each one of various nodes and the values of the scale numbers before and after the change, and the amount of traffic that flows into the service chain. Note that the service time memory apparatus 202, the control delay memory apparatus 203, and the traffic amount memory apparatus 204 may be constructed within the measurement apparatus 200 or may also be connected to the measurement apparatus 200 via an internal bus or a network.

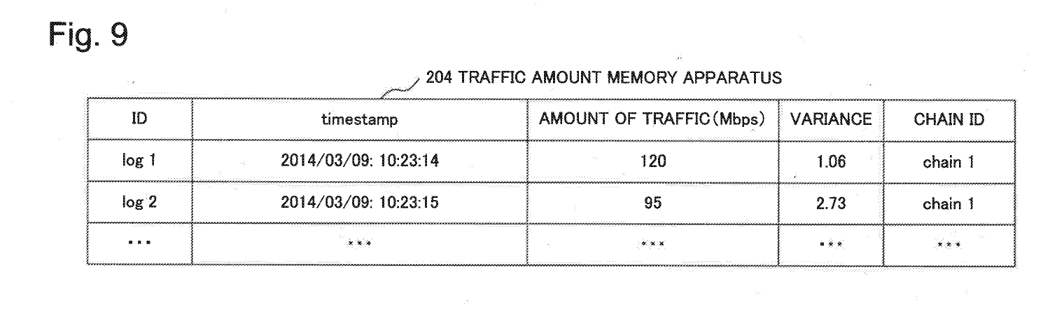

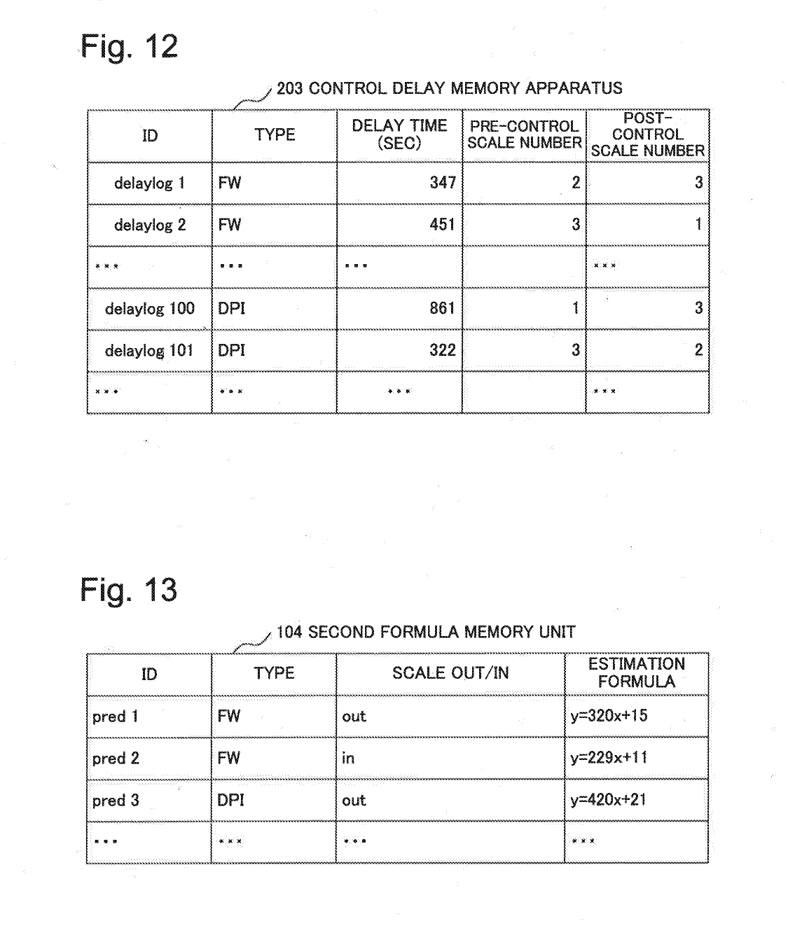

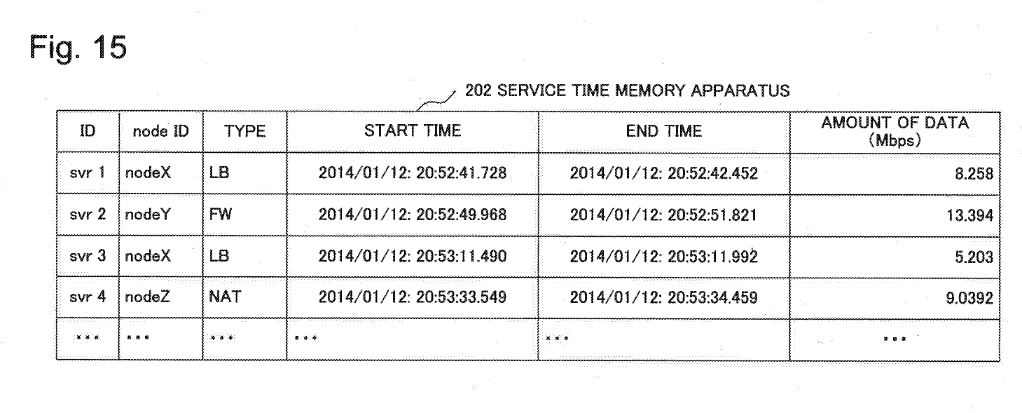

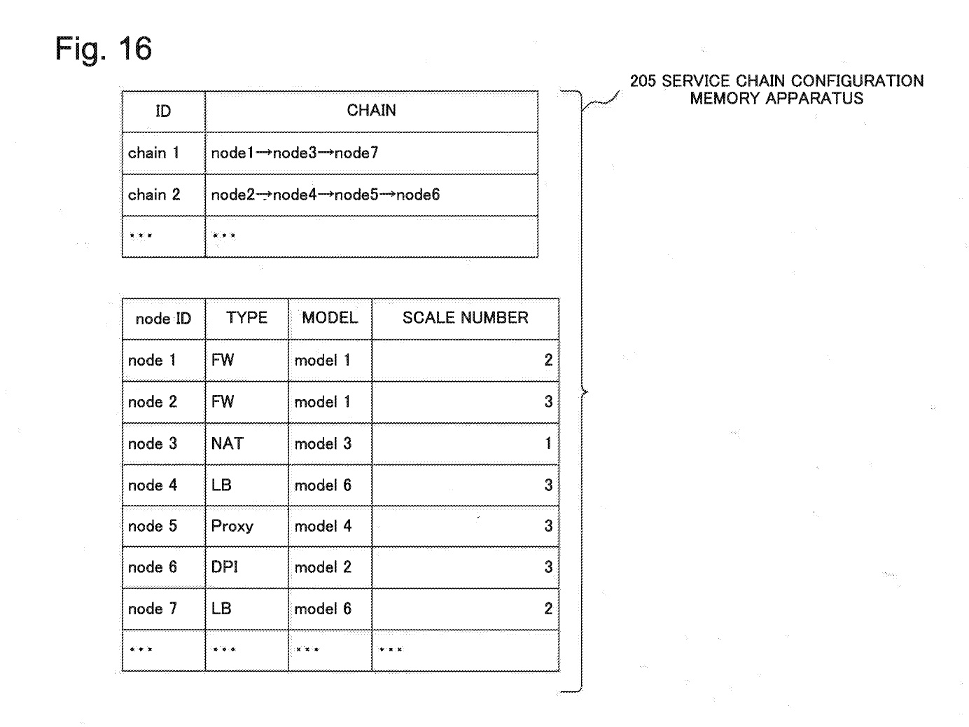

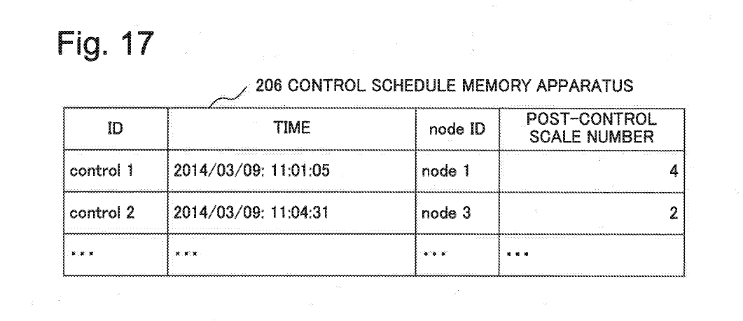

The service time memory apparatus 202 stores a log of the service time and a log of the amount of data. Data stored in the service time memory apparatus 202 will be described later with reference to FIG. 15. The control delay memory apparatus 203 stores the process delay time when the scale number is changed separately for each of various nodes and the scale numbers before and after the change. Data stored in the control delay memory apparatus 203 will be described later with reference to FIG. 12. The traffic amount memory apparatus 204 stores the log of the amount of traffic that flows into the service chain. Data stored in the traffic amount memory apparatus 204 will be described later with reference to FIG. 9. The service chain configuration memory apparatus 205 stores service chain configuration information. Data stored in the service chain configuration memory apparatus 205 will be described later with reference to FIG. 16. The control schedule memory apparatus 206 stores a control schedule of each node. Data stored in the control schedule memory apparatus 206 will be described later with reference to FIG. 17.

The control apparatus 201 executes control of a process on the service chain execution apparatus 300 based on the data stored in the control schedule memory apparatus 206 (control schedule information illustrated in FIG. 17 to be described later).

Note that the first formula generation unit 101, the second formula generation unit 103, the third formula generation unit 105, and the traffic prediction unit 107 may be constructed so as to read necessary information from the service time memory apparatus 202, the control delay memory apparatus 203, and the traffic amount memory apparatus 204.

In the service chain management system 400 described above, the first formula generation unit 101, the second formula generation unit 103, the third formula generation unit 105, the traffic prediction unit 107, the control schedule generation unit 109, the measurement apparatus 200, and the control apparatus 201 may each be constructed of hardware such as a logic circuit.

Furthermore, the first formula memory unit 102, the second formula memory unit 104, the third formula memory unit 106, the predicted traffic memory unit 108, the service time memory apparatus 202, the control delay memory apparatus 203, the traffic amount memory apparatus 204, the service chain configuration memory apparatus 205, and the control schedule memory apparatus 206 may be constructed of a memory apparatus such as a disk device and a semiconductor memory.

The service chain management system 400 may be constructed of a computer apparatus that includes a processor and a memory apparatus. In this case, the first formula generation unit 101, the second formula generation unit 103, the third formula generation unit 105, the traffic prediction unit 107, the control schedule generation unit 109, the measurement apparatus 200, and the control apparatus 201 may be realized so as to function as a processor of the service chain management system 400 that is a computer which reads a program stored in a non-volatile memory not illustrated and executes the program.

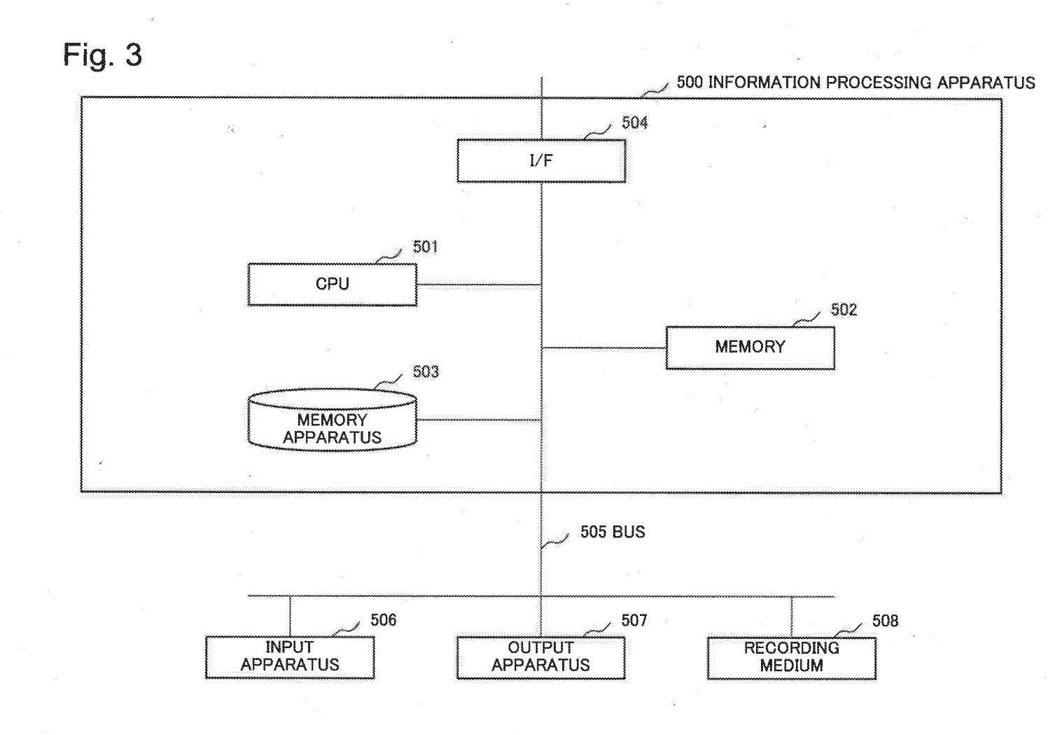

FIG. 3 is a block diagram illustrating a hardware circuit in which the service chain management system 400 in the first exemplary embodiment of the present invention is realized by an information processing apparatus 500 that is a computer apparatus. Note that each node in the service chain execution apparatus 300 may be constructed by a computer apparatus.

As illustrated in FIG. 3, the information processing apparatus 500 includes a CPU (Central Processing Unit) 501, a memory 502, a memory apparatus 503, such as a hard disk, that stores programs, and an I/F (Interface) 504 for network connection. Furthermore, the information processing apparatus 500 is connected to an input apparatus 506 and an output apparatus 507 via a bus 505. The I/F 504 corresponds to parts of the measurement apparatus 200 and the control apparatus 201 illustrated in FIG. 2.

The CPU 501 controls the entire information processing apparatus 500 by operating an operating system. Furthermore, the CPU 501 may read a program or data from a recording medium 508 that is fitted to, for example, a drive apparatus or the like, and store the program or the data into the memory 502. Furthermore, the CPU 501 functions as parts of the first formula generation unit 101, the second formula generation unit 103, the third formula generation unit 105, the traffic prediction unit 107, the control schedule generation unit 109, the measurement apparatus 200, and the control apparatus 201 in the first exemplary embodiment, and executes various processes based on programs. The CPU 501 may also be constructed of a plurality of CPUs.

The memory apparatus 503 is, for example, an optical disk, a flexible disk, a magneto-optical disk, an external hard disk, a semiconductor memory, or the like. The recording medium 508 is a non-volatile memory apparatus and records thereon programs that the CPU 501 executes. The recording medium 508 may be a part of the memory apparatus 503. Furthermore, the programs may be downloaded via the I/F 504 from an external computer not illustrated connected to a communication network.

The input apparatus 506 is realized, for example, by a mouse, a keyboard, a built-in key button, and the like, and is used for input operations. The input apparatus 506 is not limited to a mouse, a keyboard, or a built-in key button but may also be, for example, a touch panel. The output apparatus 507 is realized, for example, by a display, and is used for checking outputs.

As the above, an information processing apparatus that corresponds to the service chain management system 400 in the first exemplary embodiment illustrated in FIG. 2 is realized by the hardware configuration illustrated in FIG. 3.

However, the information processing apparatus 500 is not limited to the configuration in FIG. 3. For example, the input apparatus 506 and the output apparatus 507 may be those externally attached via the interface 504.

Furthermore, the information processing apparatus 500 may be realized by one physically united apparatus and may also be realized in such a manner that two or more physically separate apparatuses are connected by wire or wirelessly and these apparatuses realize the information processing apparatus 500.

Next, overall operations of the present exemplary embodiment will be described.

### [Derivation of Formula for Rate of Operation]

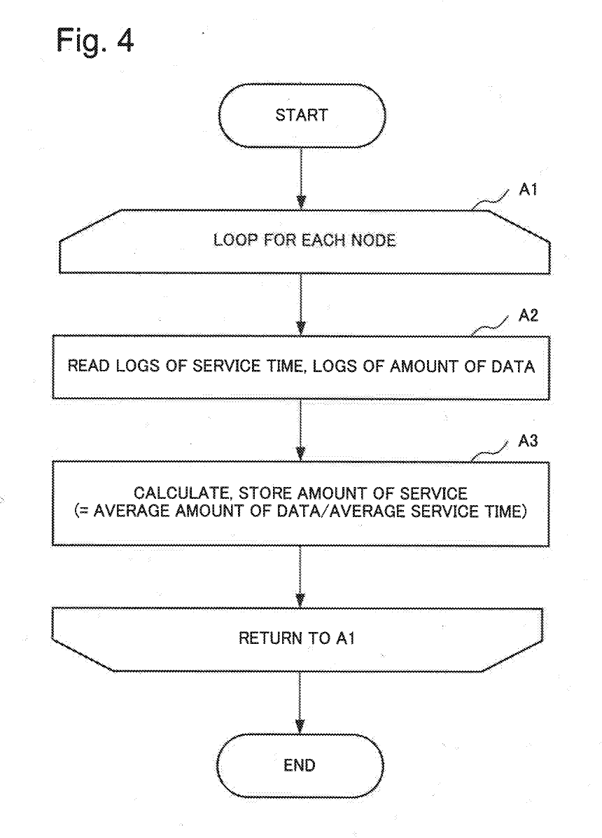

FIG. 4 is a flowchart illustrating an operation of deriving a formula for rate of operation.

The first formula generation unit 101 reads, separately for each node (step A1), logs of the service time and logs (a set of logs) of the amount of data from the service time memory apparatus 202 (step A2). FIG. 15 is a diagram illustrating an example of the service time memory apparatus 202 and information stored therein. In FIG. 15, each row indicates information that corresponds to a node at which a service occurs. Furthermore, information that corresponds to each node contains identification information (ID (identifier)) that indicates a service, node identification information (node ID), a type of the node, the starting time of the service, the ending time of the service, and the amount of data (unit: Mbps) of information about logs at the corresponding node. Note that although in FIG. 15, information about logs is omitted, logs are associated with individual IDs. Contents of information will be described later in conjunction with the exemplary embodiments.

The first formula generation unit 101 calculates an average service time separately for each of the various nodes by using each log as input data (step A3), and stores a value obtained by dividing the average amount of data by that average service time into the first formula memory unit 102 as an amount of service (step A3).

FIG. 14 is a diagram illustrating an example of the first formula memory unit 102 and information stored therein. In FIG. 14, each row indicates state information that corresponds to an object node. Furthermore, the state information that corresponds to each node contains a formula of rate of operation, a value of the rate ρ of operation, and a value of amount μ of service, separately for each ID for identification of a state and each of types of object nodes.

Note that, as a formula of rate of operation that formulates the behavior of a node, for example, a formula (1) of rate of operation in a queuing model (M/M/S) for a plurality of windows is appropriate.

$$ρ = \frac{λ}{S μ} \qquad ( 1 )$$

Note that λ indicates the amount of traffic (e.g., in Mbps) that arrives at the node, μ indicates the amount of service (unit: Mbps) that a single node instance is capable of processing, and S is the scale number that indicates the number of node instances.

The scale number S needed in order to cope with the amount of traffic λ can be determined by inputting ρ, λ, and μ in the formula (1).

### [Derivation of Control Delay Formula]

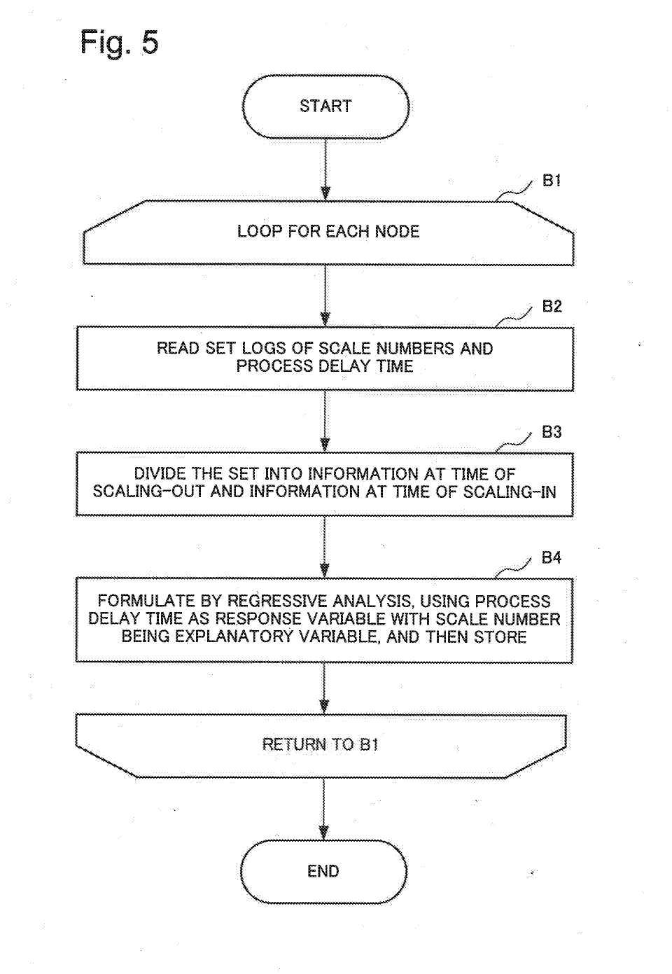

FIG. 5 is a flowchart illustrating an operation of deriving a control delay formula.

The second formula generation unit 103, separately for each of various nodes (step B1), reads a process delay time occurring at the time of change in the scale number and the values of the scale number (a set of logs) before and after the change from the control delay memory apparatus 203 (step B2). FIG. 12 is a diagram illustrating an example of the control delay memory apparatus 203 and information stored therein. In FIG. 12, each row indicates delay state information that corresponds to an object node. Furthermore, the delay state information that corresponds to each node includes an ID for identification of a delay state, the pre-control scale number and the post-control scale number, and the delay time of the process when the scale number has been changed, separately for each ID for identification of a delay state and each type of object node.

Next, the second formula generation unit 103 divides the read data into information at the time of scaling-out and information at the time of scaling-in (step B3) and, using the process delay time for each of the divisions of data as a response variable and the scale number as an explanatory variable, formulates a relation between the increased and decreased scale numbers by analysis means such as regression analysis (step B4). This is because the process delay time differs between the time of scaling-out and the time of scaling-in. After that, the second formula generation unit 103 stores this formula as a control delay formula into the second formula memory unit 104.

FIG. 13 is a diagram illustrating an example of the second formula memory unit 104 and information stored therein. In FIG. 13, each row indicates delay prediction information that corresponds to an object node. The delay prediction information that corresponds to each node includes an ID for identification of a delay prediction and control delay formulas (estimation formulas) at the time of scaling-out and the time of scaling-in separately for each type of object nodes.

### [Derivation of Traffic Predicting Formula]

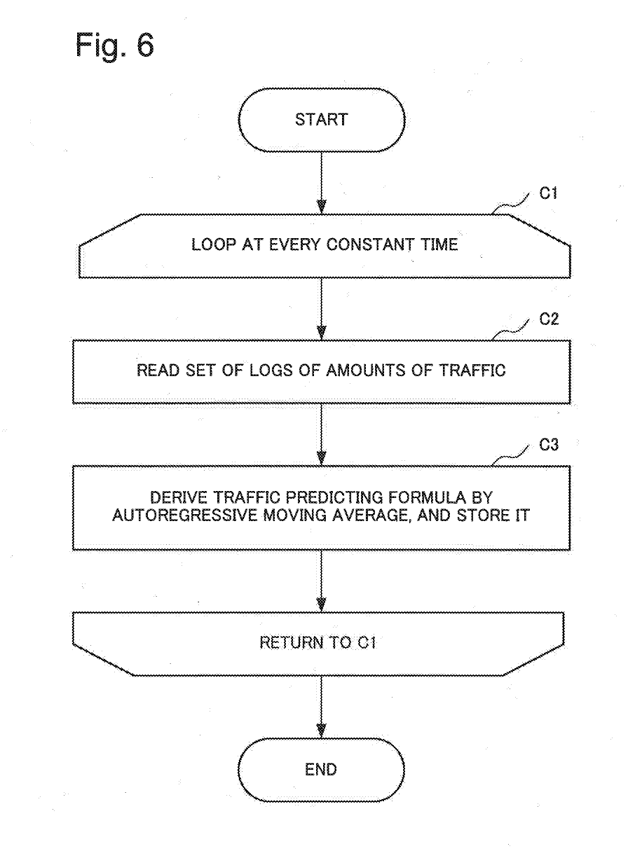

FIG. 6 is a flowchart illustrating an operation of deriving a traffic predicting formula.

First, the third formula generation unit 105, at every preset time (step C1), reads logs (a set of logs) of the amount of traffic flowing from the traffic amount memory apparatus 204 into the service chain (step C2). FIG. 9 is a diagram illustrating an example of the traffic amount memory apparatus 204 and logs stored therein. In FIG. 9, each row indicates traffic information of an object service chain. The traffic amount memory apparatus 204 stores, as the traffic information, the amounts of traffic flowing into service chains, logs on times of occurrence (timestamps), variances, IDs of logs, separately for each chain ID.

Next, the third formula generation unit 105, with regard to the logs of the amount of traffic, derives a traffic predicting formula by an analysis technique capable of predicting time series data, such as autoregressive moving average (ARMA) model, and stores the data into the third formula memory unit 106 (step C3).

FIG. 10 is a diagram illustrating an example of the third formula memory unit 106 and information stored therein. In FIG. 10, each row indicates traffic predicting formula information that corresponds to an object service chain. The third formula memory unit 106 stores, as traffic predicting formula information, traffic predicting formulas stored at every preset time, separately for each ID for data identification and each chain ID.

Note that the amount of traffic changes sharply in some cases. Therefore, in order to absorb such a change, a time series analysis technique that uses moving average, such as ARMA, is suitable. The ARMA is capable of formulation as indicated in the following formula (2) in which the amount of traffic (Mbps) at the time point t can be estimated from the amount of traffic for p times a unit time (e.g., 1 minute) in the past and the value of variance ε of the amount of traffic for q times the unit time in the past.

$${x}_{t} = {ɛ}_{t} + {\sum }_{i = 1}^{p} {φ}_{i} {x}_{t - i} + {\sum }_{i = 1}^{q} {θ}_{i} {ɛ}_{t - i} \qquad ( 2 )$$

In the above, xₜ is the amount of traffic at the time point t, εₜ is the variance at the time point t, and φᵢ and θᵢ are coefficients. i is a natural number and a value up to p or q. xₜ₋ᵢ indicates the amount of traffic at the time point of i times the unit time in the past prior to the time point t, and εₜ₋ᵢ indicates the variance of the amount of traffic at the time point of i times the unit time in the past prior to the time point t.

Note that the reason for repeating the foregoing step at every preset time (unit time) is to update the traffic predicting formula and increase the prediction accuracy. Also note that it is desirable that update of the traffic predicting formula be completed before the start of a repetitive loop for prediction schedule generation to be described later.

### [Generation of Predicted Amount of Traffic]

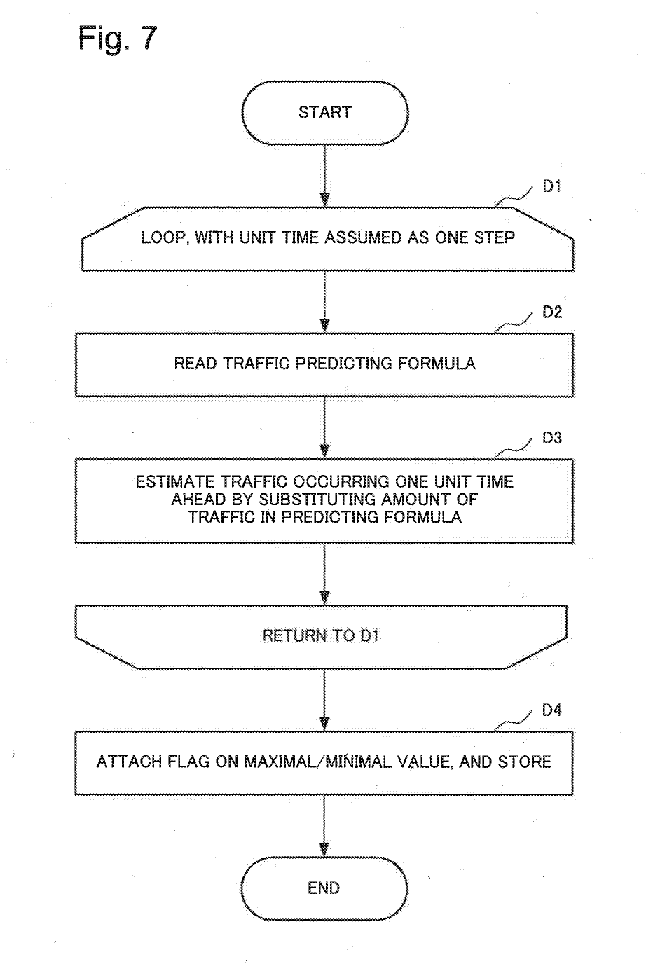

FIG. 7 is a flowchart illustrating an operation of calculating a predicted amount of traffic.

The traffic prediction unit 107 starts the loop (step D1), with the unit time being as one step, and reads the latest traffic predicting formula from the third formula memory unit 106 (FIG. 10) (step D2). Next, the traffic prediction unit 107 extracts from the traffic amount memory apparatus 204 (FIG. 9) the past amount of traffic for the number of times described in the traffic predicting formula and predicts an amount of traffic at one unit time ahead (step D3).

By repeating this calculation at every step of the unit time, the traffic prediction unit 107 calculates predicted amounts of traffic up to the time point of end of the control schedule from now on. Furthermore, the traffic prediction unit 107 attaches “maximal” or “minimal” flag information at turning points at which the predicted amount of traffic is a local maximum or a local minimum, and stores the information into the predicted traffic memory unit 108 (step D4).

FIG. 11 is a diagram illustrating an example of the predicted traffic memory unit 108 and data stored therein. In FIG. 11, each row indicates information about a predicted value of the amount of traffic. Furthermore, separately for every ID (unit time), the predicted traffic memory unit 108 stores the present time (timestamp), the predicted amount of traffic for a predetermined time ahead (e.g., 1 hour) from the present time that corresponds to each time, and turning points that include the foregoing “maximal” and “minimal” flag information. Note that n/a in the drawing indicates a state during which flag information is absent.

### [Generation of Control Schedule]

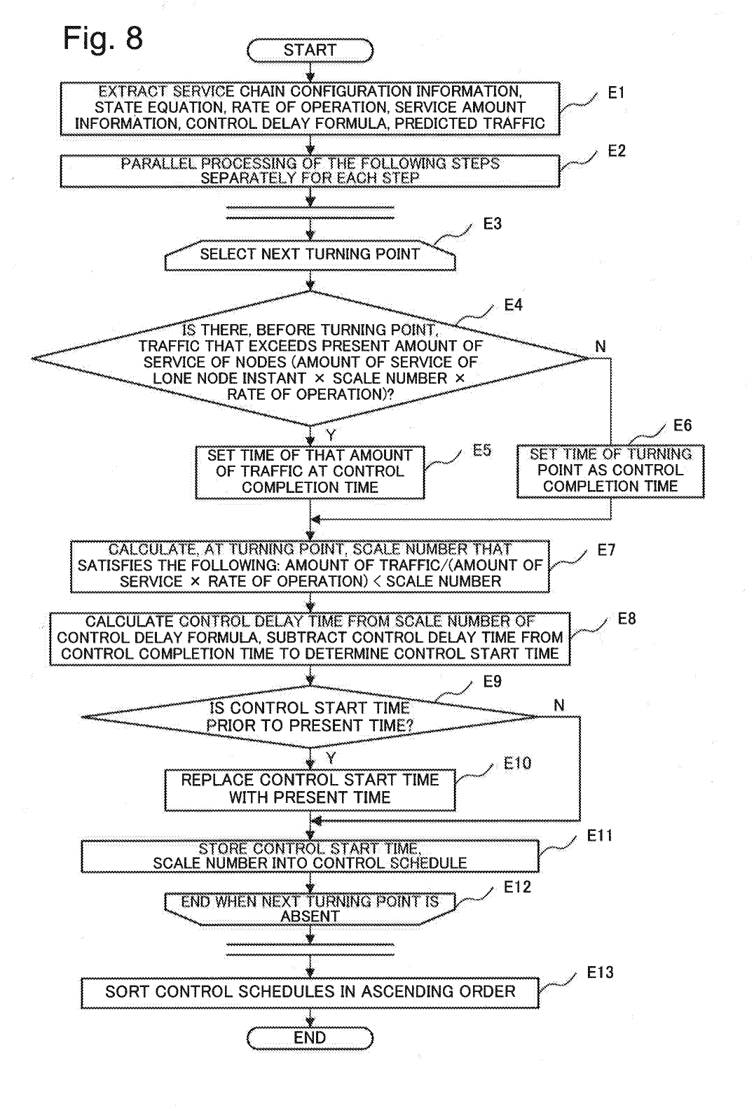

FIG. 8 is a flowchart illustrating an operation of deriving a control schedule.

The control schedule generation unit 109 extracts from the service chain configuration memory apparatus 205 service chain configuration information designated by an operator, extracts from the first formula memory unit 102 (FIG. 14) information about each of the formula for the rate of operation, the rate of operation, and the amount of service, extracts the control delay formula from the second formula memory unit 104 (FIG. 13), and extracts information about the predicted amount of traffic from the predicted traffic memory unit 108 (FIG. 11) (step E1).

FIG. 16 is a diagram illustrating an example of the service chain configuration memory apparatus 205 and data stored therein. In FIG. 16, the upper diagram represents service chain information that indicates a configuration of each service chain that operates in the service chain execution apparatus 300. Furthermore, the lower diagram of FIG. 16 indicates information about each of nodes that constitute the service chains indicated by the service chain information in the upper diagram. Information about each node includes a node ID, the type of the node, a model, and the scale number of the node. The scale number, as described above, indicates the number of instances of the nodes that constitute the service chains.

The control schedule generation unit 109 generates a control schedule at preset time intervals of 1 hour or the like. The control schedule generation unit 109 repeats a control schedule generation process described below at every preset time and, in parallel therewith, separately for each node, executes the generation of a control schedule (step E2).

First, the control schedule generation unit 109 reads information (FIG. 11) from the predicted traffic memory unit 108, and selects from the predicted amount of traffic, the next turning point (a point at which the predicted amount of traffic becomes locally maximum or locally minimum) (step E3). Next, before that turning point, the control schedule generation unit 109 determines whether there is an amount of traffic that exceeds the amount of service at the present node (the value of λ, that is, μ×S×ρ, in the formula (1) (FIG. 14)) read from the first formula memory unit 102 (step E4). Then, when there is such an amount of traffic, the control schedule generation unit 109 assumes that the time thereof as a control completion time (step E5). When there is no such amount of traffic, the control schedule generation unit 109 assumes the time of the turning point as a control completion time (step E6).

Next, the control schedule generation unit 109 calculates a scale number (after control) that enables the amount of traffic at the turning point to be processed, from a formula for the rate of operation illustrated in FIG. 14 (step E7). Then, the control schedule generation unit 109 accesses the second formula memory unit 104 and calculates a control delay time, based on the difference between the post-control scale number and the pre-control scale number (the amount x of increase or decrease of the scale number) and a control delay formula (estimation formula). Furthermore, the control schedule generation unit 109 subtracts the control delay time from the control completion time to determine a control start time (step E8). At this time, when the control start time is prior to the present time (in the past) (step E9), the control schedule generation unit 109 replaces the control start time with the present time (step E10).

Then, the control schedule generation unit 109 stores the control schedule i.e., the control start time and the scale number, into the control schedule memory apparatus 206 (step E11).

FIG. 17 is a diagram illustrating an example of the control schedule memory apparatus 206 and data stored therein. In FIG. 17, each row stores the control start time and the post-control scale number separately for each of IDs that identify control schedules and the nodes of control object.

After that, the control schedule generation unit 109 ends the loop (step E12) when the next turning point is absent, and starts the loop again when the next turning point is present.

After the process is completed with regard to all the nodes, the control schedule generation unit 109 sorts information about the control schedule of the control schedule memory apparatus 206 (FIG. 17) in the order of time (ascending order) (step E13).

After that, the control apparatus 201 extracts the control schedule from the control schedule memory apparatus 206 and, following the schedule, performs a control of the scaling out/scaling in of the service chain execution apparatus 300.

The present exemplary embodiment is constructed so that the traffic prediction unit 107 predicts a change in the amount of traffic up until after a preset time, and the control schedule generation unit 109 derives a change in the scale number and a control start timing while taking into account the change in the amount of traffic and the control delay of the node. Therefore, the present exemplary embodiment can realize dynamic optimization of the throughput performance of a service chain.

### SPECIFIC EXAMPLES

Next, using specific examples, operations of the present exemplary embodiment will be described in detail.

### [Definition of Service Chain Configuration]

A management operator who manages a service chain stores configuration information about a service chain (e.g., FW→LB→Proxy→NAT) that is operating in the service chain execution apparatus 300 in FIG. 2 into the service chain configuration memory apparatus 205 as illustrated in FIG. 16 to set the service chain as an object of automatic control.

### [Derivation of Formula for Rate of Operation]

The throughput performance of the nodes that constitute a service chain expressed by a formula for the rate of operation in a queuing model (M/M/S) (the foregoing formula (1)). Note that this formula is stored in the first formula memory unit 102 (FIG. 14).

$$ρ = \frac{λ}{S μ} \qquad ( 1 )$$

Note that λ indicates the amount of traffic that arrives (e.g., Mbps), μ indicates the amount of service (e.g., Mbps) that a single node instance can process, and S indicates the scale number that indicates the number of node instances. The scale number S is defined in the service chain configuration memory apparatus 205 (FIG. 16). The rate of operation ρ indicates the degree of crowdedness (0 to 1) in the process at each node. As the degree of crowdedness becomes closer to 1, the waiting time becomes longer. In this example, the degree of crowdedness is designated as being 0.7 so as to restrain the waiting time (FIG. 14).

Furthermore, the amount of service μ is calculated by the first formula generation unit 101. The first formula generation unit 101 acquires from the service time memory apparatus 202 the service starting time and ending time at each node as illustrated in FIG. 15. Then, the first formula generation unit 101 assumes the difference between the ending time and the starting time of a service as a service time, calculates an amount of service μ (Mbps) that indicates a processing capability from an average of the service time and an average of the amount of data, and stores it as a value in the column of the amount of service in the first formula memory unit 102 (FIG. 14).

### [Derivation of Control Delay Formula]

It is assumed that the process delay time at the time of increase or decrease of the scale number of nodes can be linearly approximated. The control delay memory apparatus 203, as illustrated in FIG. 12, stores the pre-control scale number, the post-control scale number, and the delay time occurring before the node instance generation, the network setting, and the node instance setting change are completed.

The control delay memory apparatus 203, where the object node is FW for example, can perform formulation indicated in the following formula (3) by extracting from data about the FW a data set with the increasing scale number and performing regression analysis.

y=320x+15 (3)

In the above, x indicates the amount of increase or decrease of the scale number and y indicates the delay time.

Note that since the process delay time is different between the time of scaling-out and the time of scaling-in, the formulation needs to be separately performed.

The second formula generation unit 103 sets this formula as a control delay formula (estimation formula) at the time of scaling-out of the FW and stores the formula into the second formula memory unit 104 as illustrated in FIG. 13.

### [Derivation of Traffic Predicting Formula]

Autoregressive moving average (ARMA) is used for prediction of the amount of traffic that flows into a chain. The third formula generation unit 105 extracts past logs of the amount of traffic as illustrated in FIG. 9 from the traffic amount memory apparatus 204. These logs have been recorded at every unit time.

In the ARMA, the range of going back to the past is set as being [1≦p≦6 and 1≦q≦6], traffic predicting formulas with varied combinations of p and q are generated, and a formula of which Akaike's Information Criterion (AIC) is the smallest is selected as an optimum formula. For example, in the traffic predicting formula at the time point of “2014/03/09: 08:00”, the combination of p and q with which the AIC is the smallest is p=2 and q=3, whereby the coefficients of the foregoing formula (2) are determined. Consequently, the third formula generation unit 105 generates a formula (4) below. Then, the third formula generation unit 105 stores the traffic predicting formula into the third formula memory unit 106 as illustrated in FIG. 10.

xᵢ=0.545xₜ₋₁−0.523xₜ₋₂+0.546εₜ₋₁+0.656εₜ₋₂+0.03εₜ₋₃+1.07 (4)

This traffic predicting formula is generated at preset intervals. The intervals are, for example, assumed to be 1 hour.

### [Generation of Predicted Amounts of Traffic]

The traffic prediction unit 107 extracts the latest traffic amount predicting formula from the third formula memory unit 106 illustrated in FIG. 10. For example, when the value of p is 2 and the value of q is 3 in the traffic amount predicting formula, the traffic prediction unit 107, uses the larger value, extracts traffic information corresponding to the past three occasions that include the present time from the traffic amount memory apparatus 204 illustrated in FIG. 9, and estimates the amount of traffic at the time of one unit time ahead from the predicting formula.

Then, the traffic prediction unit 107 estimates the amount of traffic for 1 hour from the present time by repeating this calculation 60 times and stores the estimated amount in the predicted traffic memory unit 108 as illustrated in FIG. 11. Furthermore, at turning points at which the predicted amount of traffic is a local maximum or a local minimum in those data for 1 hour, the traffic prediction unit 107 attaches the “maximal” or “minimal” flag information that indicates the local maximum or the local minimum.

### [Generation of Control Schedules]

The control schedule generation unit 109 extracts service chain configuration information illustrated in FIG. 16 from the service chain configuration memory apparatus 205 at every 1 hour, extracts information about the formula for the rate of operation, the rate of operation, and the amount of service illustrated in FIG. 14 from the first formula memory unit 102, extracts control delay formulas shown in FIG. 13 from the second formula memory unit 104, and extracts information about the predicted amount of traffic for the coming 1 hour as illustrated in FIG. 11 from the predicted traffic memory unit 108. Then, the control schedule generation unit 109 generates control schedules by parallel processing, separately for each node.

For example, in the FW of a node 1, the scale number at the control schedule starting time (present time) is “S=2” (FIG. 16). Furthermore, the formula for the rate of operation is a formula (5) indicated below (FIG. 14).

$$0.7 = \frac{λ}{S \times 50.2} \qquad ( 5 )$$

That is, the amount of traffic λ is “70.3 (Mbps)”.

The predicted traffic in FIG. 11 reaches the first turning point (local maximum) at the time point of “2014/03/09:11:18:00” but has an amount of traffic of “72 (Mbps)” at the time point of “2014/03/09:11:12:00”. In other words, the control schedule generation unit 109 can detect that the scale number of “2” at the starting time point will result in insufficient processing capability.

Therefore, the control schedule generation unit 109 needs to set “2014/03/09: 11:12:00” as the first control completion time and to finish increasing the scale number by this time point.

Furthermore, the scale number that allows the processing of the amount of traffic of “138 (Mbps)” at the turning point of “2014/03/09:11:18:00” is “S=4” from the formula for the rate of operation. In this case, the amount of traffic λ is “140.6 (Mbps)”.

Note that the control delay formula at the time of scaling-out at the FW is the foregoing formula (3) (FIG. 13).

y=320x+15 (3)

Assuming the increment in the scale number as “x=2”, the formula (3) estimates a control delay of 655 (seconds). Therefore, the control schedule generation unit 109 creates a control schedule of the FW in which “2014/03/09: 11:01:05”, which is 655 seconds before the control completion time of “2014/03/09: 11:12:00”, is set as the control start time and the post-control scale number is set to “S=4”, and stores the schedule into the control schedule memory apparatus 206 as illustrated in FIG. 17.

By repeating such a process, the control schedule generation unit 109 creates control schedules. Then, after completion of the processing for all the nodes, the control schedule generation unit 109 sorts the control schedules in the control schedule memory apparatus 206 into the order (ascending order) of time.

The control schedule generation unit 109 repeats the control schedule generation process at every 1 hour. Accordingly, the service chain management system 400 becomes capable of an automatic control that is ready for changes in the amount of traffic in the network of the service chain execution apparatus 300.

The control apparatus 201 extracts control schedules for 1 hour as illustrated in FIG. 17 from the control schedule memory apparatus 206 and performs the control of scaling out/scaling in according to the schedules.

The service chain management system 400 according to the present exemplary embodiment achieves advantageous effects as described below.

The service chain management system 400 can realize dynamic optimization of the throughput performance of a service chain.

The reason is that the service chain management system 400 predicts changes in the amount of traffic in the future and, furthermore, takes into account the control delays at the node to derive a change in the scale number and a control start timing.

### Second Exemplary Embodiment

Next, a second exemplary embodiment of the present invention will be described in detail with reference to the drawings.

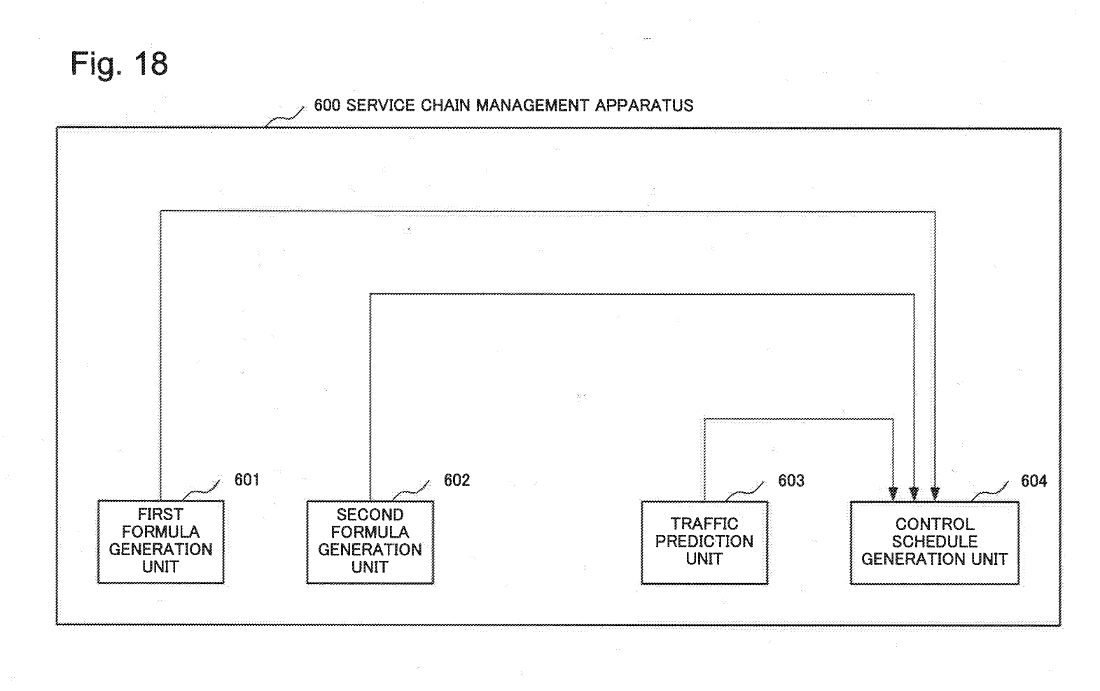

FIG. 18 is a block diagram illustrating an example of a configuration of a service chain management apparatus 600 according to the second exemplary embodiment of the present invention.

The service chain management apparatus 600 includes a first formula generation unit 601, a second formula generation unit 602, a traffic prediction unit 603, and a control schedule generation unit 604.

The first formula generation unit 601 generates a formula (first formula) that formulates a relation between the scale number that indicates the number of instances of a node that constitutes a service chain and the amount of service that the node is capable of processing.

The second formula generation unit 602 generates a formula (second formula) that formulates a relation between an increase or decrease of the scale number and the delay time of the processing at a node.

The traffic prediction unit 603 predicts a post-preset time amount of traffic by using a measured value of the amount of traffic in the service chain.

With respect to a node, the control schedule generation unit 604 calculates the increase or decrease of the scale number that is needed after a preset time, from the amount of service that allows the post-preset time amount of traffic to be processed, based on the first formula, and calculates a delay time from the increase or decrease of the scale number, based on the second formula, and generates a control schedule in which the timing of the increase or decrease of the scale number has been set, based on the delay time.

The service chain management apparatus 600 according to the present exemplary embodiment achieves advantageous effects as described below.

The service chain management apparatus 600 can realize dynamic optimization of the throughput performance of a service chain.

A reason is that the service chain management apparatus 600 predicts changes in the amount of traffic in the future and, furthermore, takes into account the control delays at the nodes to derive a change of the scale number and a control start timing.

While the exemplary embodiments of the present invention have been described above with reference to the drawings, the present invention is not limited to the foregoing exemplary embodiments. The configuration and details of the present invention can be changed in various manners that are understandable by a person skilled in the art within the scope of the present invention.

This application claims the priority based on Japanese Patent Application No. 2014-125989 filed Jun. 19, 2014, the disclosure of which is incorporated herein in its entirety.

### REFERENCE SIGNS LIST

100 Service chain management apparatus

101 First formula generation unit

102 First formula memory unit

103 Second formula generation unit

104 Second formula memory unit

105 Third formula generation unit

106 Third formula memory unit

107 Traffic prediction unit

108 Predicted traffic memory unit

109 Control schedule generation unit

200 Measurement apparatus

201 Control apparatus

202 Service time memory apparatus

203 Control delay memory apparatus

204 Amount of traffic memory apparatus

205 Service chain configuration memory apparatus

206 Control schedule memory apparatus

300 Service chain execution apparatus

400 Service chain management system

500 Information processing apparatus

600 Service chain management apparatus

601 First formula generation unit

602 Second formula generation unit

603 Traffic prediction unit

604 Control schedule generation unit

What is claimed is:

1. A service chain management apparatus comprising:
a first formula generation unit that generates a first formula that formulates a relation between a scale number that indicates number of instances of a node that constitutes a service chain and an amount of service that the node is capable of processing;
a second formula generation unit that generates a second formula that formulates a relation between an change in the scale number and a delay time of the processing at the node;
a traffic prediction unit that predicts, using a measured value of an amount of traffic in the service chain, the amount of traffic that occurs after a preset time; and
a control schedule generation unit that, with respect to the node, calculates the change in the scale number that is needed after the preset time, from the amount of service that allows the amount of traffic that occurs after the preset time to be processed, based on the first formula, calculates the delay time from the change in the scale number, based on the second formula, and generates a control schedule in which a timing is set for the change in the scale number, based on the delay time.

2. The service chain management apparatus according to claim 1, further comprising
a traffic predicting formula generation unit for deriving a traffic amount change predicting formula by a time series analysis technique by using a measured value of the amount of traffic,
wherein the traffic prediction unit predicts the amount of traffic based on the traffic amount change predicting formula.

3. The service chain management apparatus according to claim 1, wherein the control schedule generation unit sorts the control schedules that correspond to a plurality of the node in order of time.

4. A service chain management system comprising:
the service chain management apparatus according to claim 1;
a measurement apparatus that measures the amount of service, the delay time that corresponds to the change in the scale number, and the amount of traffic, from a service chain execution apparatus that executes the service chain; and
a control apparatus that controls the service chain execution apparatus so as to perform a control of the change in the scale number of the node that is an object based on the control schedule.

5. A service chain management method comprising:
generating a first formula that formulates a relation between a scale number that indicates number of instances of a node that constitutes a service chain and an amount of service that the node is capable of processing;
generating a second formula that formulates a relation between a change in the scale number and a delay time of the processing at the node;
predicting, by using a measured value of an amount of traffic in the service chain, the amount of traffic that occurs after a preset time; and
with respect to the node, calculating the change in the scale number that is needed after the preset time, from the amount of service that allows the amount of traffic that occurs after the preset time to be processed, based on the first formula, and calculating the delay time from the change in the scale number, based on the second formula, and generating a control schedule in which a timing is set for the change in the scale number, based on the delay time.

6. The service chain management method according to claim 5 further comprising:
deriving a traffic amount change predicting formula by a time series analysis technique by using a measured value of the amount of traffic; and
predicting the amount of traffic based on the traffic amount change predicting formula.

7. The service chain management method according to claim 5 further comprising sorting the control schedules that correspond to a plurality of the node in order of time.

8. A computer-readable program recording medium that records a program that causes a computer to execute:
a process of generating a first formula that formulates a relation between a scale number that indicates number of instances of a node that constitutes a service chain and an amount of service that the node is capable of processing;
a process of generating a second formula that formulates a relation between a change in the scale number and a delay time of the processing at the node;
a process of predicting, by using a measured value of an amount of traffic in the service chain, the amount of traffic that occurs after a preset time; and
a process of, with respect to the node, calculating the change in the scale number that is needed after the preset time, from the amount of service that allows the amount of traffic that occurs after the preset time to be processed, based on the first formula, and calculating the delay time from the change in the scale number, based on the second formula, and generating a control schedule in which a timing is set for the change in the scale number, based on the delay time.

9. The program recording medium according to claim 8 that causes the computer to further execute:
a process of deriving a traffic amount change predicting formula by a time series analysis technique by using a measured value of the amount of traffic; and
a process of predicting the amount of traffic based on the traffic amount change predicting formula.

10. The program recording medium according to claim 8 that causes the computer to further execute a process of sorting the control schedules that correspond to a plurality of the node in order of time.
